(19) United States
(12) Patent Application Publication
(10) Pub. No.: US 2021/0027369 A1
(43) Pub. Date: Jan. 28, 2021

(54) DECENTRALIZED ALGO-SHARING INFRASTRUCTURE FOR ZERO-LOSS ALGORITHMIC TRADING

(71) Applicants: Fazal RAHEMAN, Nagpur (IN); Ali RAHEMAN, Nagpur (IN); Sajid ANWAR, Nagpur (IN)

(72) Inventors: Fazal RAHEMAN, Nagpur (IN); Ali RAHEMAN, Nagpur (IN); Sajid ANWAR, Nagpur (IN)

(21) Appl. No.: 16/969,002

(22) PCT Filed: Feb. 6, 2019
(86) PCT No.: PCT/IB2019/050949

§ 371 Date: Aug. 11, 2020

Related U.S. Application Data
(60) Provisional application No. 62/629,609, filed on Feb. 12, 2018.

(51) Int. Cl. G06Q 40/04; G06Q 40/02; G06Q 40/06; G06F 16/182

(52) U.S. Cl. CPC G06Q 40/04; G06Q 40/025; G06Q 20/1085; G06F 16/1837; G06Q 40/06

(57) ABSTRACT

The present invention discloses a decentralized Zero-Loss Ecosystem for generating and spreading the wealth based on incentivized and equitable sharing of assets between peers according to their haves or needs, without taxing the economy. Specifically it relates to the field of algorithmic trading, automated trading or high frequency trading (HFT) of financial instruments. More specifically it relates to systems, apparatus, and methods to create, verify, and maintain a cloud-based autonomous, decentralized blockchain network infrastructure of self-executing smart contracts for sharing the most profitable trading strategies with participating peers so that anyone without any trading experience or capital can profit from automated Zero-Loss trading completely risk-free utilizing fully secured Zero-Loss, Zero-Credit financing.

### TECHNICAL FIELD

The present invention generally relates to the brand new sharing economy or sharonomics. Specifically it relates to the field of algorithmic trading, automated trading or high frequency trading (HFT) of financial instruments. More specifically it relates to systems, apparatus, and methods to create, verify, and maintain a cloud-based autonomous, decentralized blockchain network infrastructure of self-executing smart contracts for sharing the most profitable trading strategies with participating peers so that anyone without any trading experience or capital can profit from automated trading completely risk-free utilizing fully secured zero-loss financing. As reasons therefore this invention enables a spreading of wealth and alleviating poverty without taking from the affluent or taxing the economy.

### BACKGROUND OF THE INVENTION

Sharing economy or sharonomics has been consistently gaining popularity worldwide. Technology enabled sharing of assets for mutual benefits is the latest trend. In recent years this new industry has witnessed several billion-dollar disruptions in sharing assets such as homes (Airbnb), cars (Uber), bikes (Mobike, Ofo). Technology has made sharing of tangible assets like home, car, bike, etc., a convenient and profitable option for utilizing these assets' idle time. However, securely sharing non-tangible or virtual assets still appears to be a bit challenging. Whether sharing tangible assets or virtual assets, decentralization, such as with blockchain, can play an important role.

Algorithmic Trading (aka Automated Trading, or simply Algo-trading) is the process of using computers programmed to follow a defined set of instructions for placing a trade in order to generate profits at a speed & frequency that's impossible for a human trader.

With $5+ Trillion daily trades, currency trading is by far the biggest asset class in the world. Adding stocks, bonds, commodities & the new asset class: cryptocurrency, the daily trading volume reaches close to $6 Trillion. Currently 75% of all trading is automated algorithm based. In other words Algo-trading handles almost $4 Trillion worth of trades every day. No other industry even comes close to the colossal size of the assets that change hands on a daily basis. To profit in electronic market places, especially those hosting volatile financial instruments (such as cryptocurrencies), a user must be able to react quickly.

The big chunk of these HFT (high frequency trading) transactions are controlled by powerful computers operated by big banks, mutual funds, hedge funds, insurance companies, institutional investors, etc. They've invested a small fortune developing trading algorithms. Advanced algorithmic trading bots use several indicators in thousands of possible combinations to design their profit-making strategies making it too complex and beyond reach of individual traders/users. It certainly leaves retail investors at a disadvantage.

Although advancements in Artificial Intelligence and processing speeds are pushing the limits, algo-trading is still not an exact science that guarantees profits & eliminates losses altogether. It has reached a threshold beyond which its efficacy may not be pushed to any significant level. And, it certainly isn't accessible to common man. Winning algorithmic trading strategies are rare and short lived. Sharing it with peers while that window of opportunity is still open, generates new revenue streams. The ability to share a winning Algorithmic trading strategy with peers not only ensures profits to the one who owns the Algo but to anyone who rents it.

As reasons therefore this invention introduces a very novel concept of sharing top performing profitable trading algorithms with peers. Algo-sharing democratizes Algo-trading and brings it into the hands of anyone who owns a basic computer or smart device and a small capital or no capital with Zero-Loss trading and Zero-Loss financing.

Algosharing can not only bring safe, secure, profitable zero-loss algo-trading to newbies, but most importantly it can be deployed for spreading the wealth without taxing the economy or taking it from the rich and giving it to poor. According to recent reports there is a major “ZeroWealth” crisis brewing, which predicts that median black US household is on road to Zero Wealth by 2053. Poverty eradication is United Nation's number one goal for sustainable development, which still remains greatest global challenge facing the world today. Looking at the growing wealth gap trends, the UN agenda to end poverty by 2030 looks virtually impossible. In the given circumstance Algosharing holds out much hope of alleviating poverty by spreading the wealth without taxing the economy or taking it away from the affluent.

Algosharing is a perfect example of how blockchain can make algorithmic trading shareable, profitable and accessible to all with zero risk of loosing (Zero-Loss). Because algosharing is Zero-Loss trading, it creates new opportunities for everyone, particularly the extremely poor with zero capital to avail Zero-Loss financing from financial institutions who would be more than willing to fund an algosharing account that secures the principle by limiting withdrawals to the profits over and above the loaned capital plus interest. Most importantly, Algosharing is capitalism's way of spreading the wealth and reducing the perpetually growing wealth gap between rich & poor without taxing the affluent.

Besides security, autonomy, transaction speeds, one key feature of sharing economy is an agreement between peers to share, lease, rent assets under certain terms & conditions. Blockchain is the prefered technology that can do all of that seamlessly, securely & economically. It can make algo-trading shareable, profitable & accessible to everyone. With Trillions in daily volumes, Algosharing is poised to not only be the next big thing in fintech, but a revolutionary way of spreading the wealth and reducing the extreme wealth inequality. All isms—capitalism, Socialism, Communism, Marxism—claim to be pro-humanity, but all of them have so far failed to alleviate the fundamental right of equality. The approach disclosed in this invention is non-partisan and does not conflict with any of the isms. It just equitably, democratically and indiscriminately spreads the wealth to bring prosperity across humanity. Therefore, in philosophical terms, we call it PROSPERISM and define it as a decentralized zero-loss ecosystem for generating and spreading the wealth based on incentivized and equitable sharing of assets between peers according to their haves or needs, without taxing the economy.

The present invention discloses systems, apparatus and methods to create, verify, and maintain a cloud-based decentralized network infrastructure of algorithmic trading peers that autonomously generates a list of high performing algorithmic trading strategies and makes them available for safe and secure lease out to peer participants for the purpose of making profitable trades. Such autonomous network infrastructure generally relates to permissionless distributed databases more particularly to blockchains. Blockchains are replicated ledgers of transactions between peers that save their data in sequential data files at each of the peer nodes. Such peer-to-peer transactions or smart contracts are verified in blockchain by having multiple computer systems hash the data describing a smart contract transaction and when a majority of computer systems compute the same hash, the transaction is considered verified and added to the replicated ledgers. In simpler terms the present invention discloses a computer-implemented system, apparatus and method of utilizing an autonomous decentralized system of blockchain's distributed ledger infrastructure and self-executing smart contracts for securely, confidentially and equitably sharing with or leasing to participating peers, top performing algorithmic trading strategies based on a trading algorithm performance global leaderboard, for the purpose of trading financial instruments or assets on one or more trading platforms or exchanges.

Directed Acyclic Graph (DAG) is another alternate technology to implement a decentralized network.

### BRIEF SUMMARY OF THE INVENTION

It would be an improvement to provide a novel algo-sharing infrastructure for sharing with peers, top performing algorithmic trading strategies, and deploying them in profitable trades. It would also be an improvement to make such sharing/leasing private, safe, secure, seamless and loss-proof. It would therefore be an improvement that such algo-sharing system is administered by means of an autonomous, peer-to-peer, decentralized, permissionless, trustless, network that maintains immutable cryptographically verifiable transaction records of profitable algorithmic strategies that make it to the leaderboard, that are leased by peers, used in placing trades, and the fee paid thereof. It would therefore be an improvement that algo-sharing is implemented by deploying a distributed blockchain ledger or a distributed smart contract system for immutably recording the status of each trade executed within the system in reference to their corresponding algo-sharing contracts with the peers.

Accordingly, this invention discloses a computer implemented, Internet-connected algo-sharing infrastructure for democratizing the algorithmic trading industry and making the complex algo-trading activities accessible to anyone with a basic computing device without the need of a trading robot. As reasons therefore, it is an object of this invention to provide an algo-sharing infrastructure for sharing/leasing that's safe, secure, seamless and plagiarism-free by means of encrypting the leased algorithm using private key and public key infrastructure so that it can neither be replicated nor reconfigured nor reverse engineered by the peers who lease it. It is also an object to provide an algo-sharing system to handle algorithmic trading of diverse financial instruments or assets belonging to one or more of the asset class consisting of currencies, stocks, equities, futures, options, commodities, bonds, warrants or cryptocurrencies.

It would be a further object to provide a system wherein the trading algorithm performance leaderboard is updated and published either in real time, every minute, every hour, every 12-hours, every 24-hours or every week, and consequently top performing algorithms made available for equitable sharing with or leasing to peers for a consideration that may either be on fixed fee basis, or based on a share in the trading profits according to specific terms defined in the smart contract. It would also be another object to provide a method of self-executing smart contract between the lessor and the lessee of the leased algorithm verified by consensus of participating peers and immutably maintained in a database of distributed ledger amongst the participating nodes. It would be a further object to limit the use of the contracted algo to trading specific financial instruments during specific time periods within specific trading exchanges deploying artificial intelligence for eliminating any residual risk in trading decisions due to any real time changes in market conditions that impact the profitability of the leased algorithm.

It would also be object of this invention to provide an artificial intelligence engine that deploys machine learning and deep learning algorithms to perform stochastic modeling of data obtained via global and local surveillance of financial markets, to determine profitability half-life of various algorithmic trading strategies. It is also yet another object of the invention to provide insurance coverage to the top performing algo-trading strategies against unforeseeable losses.

It is also further object of the invention to implement algo-sharing in high frequency trading (HFT) settings allowing peers to define the value and frequency of the trades.

It is yet another object of the invention to deploy algo-sharing to inter-exchange arbitrage trading or intra-exchange arbitrage trading. It is further object of the invention to match the transaction speeds of HFT with low latency and scalable blockchain.

It is yet another object of the invention to extend algorithm sharing to any asset that represents value of ownership and not just financial instruments. It is still further object of the invention to create a new class of Zero-Loss loans, which are 100% secured with zero possibility of default. Such Zero-Loss loan capital cannot be withdrawn or used for any other purpose than algotrading using the most profitable algorithm topping the leaderboard. It is yet another object of the invention to spread the wealth by enabling participation of impoverished individuals or their cooperatives by extending secured nano-loans or micro-loans of not less than $100 and not more than $1000 for acquiring tradable financial instruments or assets for algo-trading. Such loans are under the terms that the loaned principle is used for algo-trading but cannot be withdrawn, and the trading profits are withdrawable to the extent that they are over and above the estimated interest on the loan.

It is still further object of the invention to provide automatic teller machines (ATM) to enable last mile delivery of financial and profit making algo-sharing, algo-trading and financial instrument exchange services to remote end-users who do not have a computer device or chose not to use a personal computer device.

It is yet another object of the invention to provide the use of traditional centralized database infrastructure where decentralized blockchain infrastructure cannot be implemented.

The foregoing discussion summarizes some of the more pertinent objects of the present invention. These objects should be construed to be merely illustrative of some of the more prominent features and applications of the invention. Applying or modifying the disclosed invention in a different manner can attain many other beneficial results as will be described in detail herein. Accordingly, referring to the following drawings may have a complete understanding of the invention and its preferred embodiments.

### BRIEF DESCRIPTION OF DRAWINGS

FIG. 1 is a block diagram illustrating the network architecture of a novel embodiment of the algo-sharing system.

FIG. 2 is a block diagram illustrating the steps of the novel algo-sharing method.

FIG. 3 is a block diagram illustrating the stochastic modeling of surveillance data for determining profitability half-life of the algorithmic trading strategy.

### DETAILED DESCRIPTION

The core feature of the instant invention is decentralized, seamless, autonomous, safe, secure and equitable sharing of top performing algorithmic trading strategies to peers for the purpose of utilizing those strategies for profitable trading of various financial instruments according to the terms of a smart leasing contract. Such novel approach of autonomous algo-sharing in diverse trading environments can be deployed in many different ways, and accordingly several embodiments of the invention are possible. Before a few preferred embodiments of the invention are described in detail, following technical terms used in describing the invention need to be clearly defined:

Algorithmic Trading (aka Automated Trading, or simply Algo-trading) is the process of using computers programmed to follow a defined set of instructions for placing a trade in order to generate profits at a speed & frequency that's impossible for a human trader. The term is used interchangeably with trading strategy, algorithmic trading strategy (ATS) or algo strategy or simply algo.

Algo-sharing (Algosharing or Algoshare) is computer-implemented system, apparatus and method of utilizing an autonomous decentralized system of distributed ledger infrastructure and self-executing smart contracts for securely, confidentially and equitably sharing with or leasing to participating peers, top performing algorithmic trading strategies based on a trading algorithm performance global leaderboard, for the purpose of trading financial instruments or assets on one or more trading platforms or exchanges. This is also termed Zero-Loss trading.

Profitability Half-Life of ATS: Profitability of ATS is never permanent. It changes according to market conditions. To determine the duration of profitability of any ATS, an artificial intelligence (AI) module runs advance machine learning and deep learning algorithms to analyze large amount of global and local surveillance data. The AI module uses such stochastic data from financial markets to model the dynamic half-life of the ATS. Such half-life remains dynamic and subject to change depending on exposure to some extreme random event, which may result in shortening or curtailing the profitability the half-life, or giving the ATS a new life.

A Blockchain is a decentralized distributed database that maintains a continuously growing list of data records hardened against tampering and revision. It consists of data structure blocks, which hold exclusively data in initial blockchain implementations, and both data and programs in some of the more recent implementations—with each block holding batches of individual transactions and the results of any blockchain executables. Although originally a backbone of cryptocurrencies, blockchain protocols can be a boon to any P2P infrastructure where peers can seamlessly self-execute smart contracts securely without having to disclose their identities.

Directed Acyclic Graph (DAG): DAG is an alternate decentralizing technology that is faster and lighter than blockchain.

Global Trading Leaderboard or a Leaderboard, in the context of this invention, is a dynamic list of top performing algorithmic trading strategies published for the purpose of making them available for leasing to peers at predefined intervals depending on the type of financial instrument being traded.

Financial Instruments are assets that belong to one or more of the asset class consisting of currencies, stocks, equities, futures, options, commodities, bonds, warrants or cryptocurrencies.

Zero-Loss Financing (ZLF): ZLF creates a new class of loans that are 100% secured with almost zero possibility of default. The default possibility is approaches zero because:

Firstly, loaned capital cannot be withdrawn or used for any other purpose than algo-trading using the most profitable algorithm topping the leaderboard. Only profits can be withdrawn to the extent that they are over and above the estimated interest on the loan.

Secondly, the leased algorithm is deployed for trading within its estimated profitability half-life, and as additional safeguard an artificially intelligent stop-loss mechanism protects against any unpredictable losses. Zero-Loss loans therefore are 100% secured.

Zero-Loss Ecosystem: The Zero-Loss Algo-shared trading and the Zero-Loss financing create a socioeconomic ecosystem that allows individuals with Zero-Credit and Zero-Capital to participate and profit from the system.

Trading Exchange is a marketplace for trading on or more financial instruments.

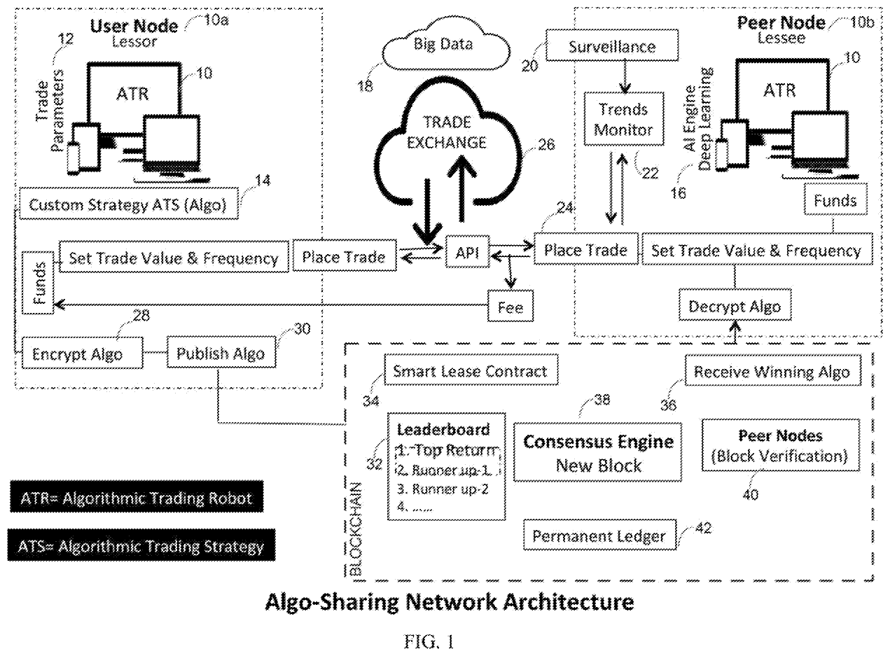

Embodiments of the present invention will now be described with reference to FIGS. 1-3, which in general relate to a computer-implemented system for equitable sharing of profitable algorithmic trading strategies with peers for the purpose of deploying such top performing algos for trading assets on trading platforms or exchanges.

As illustrated in FIG. 1, the infrastructure for implementing the algo-sharing system and method of the present inventions includes a network architecture and apparatus comprising of the following components or modules distributed and installed on the participating devices or remote servers comprising of the nodes that communicate with each other in a decentralized network:

Algorithmic Trading Robot (ATR): An ATR 10 is a computing device at the user node (lessor of the algo) 10a, or at the peer node 10b (lessee of the algo), which is used:

at the user node 10a to design algorithmic trading strategies using multiple trading parameters based on one or more trading indicators known to prior art, for trading financial instruments on a trading exchange, and for encrypting and publishing the algo to the leaderboard of top performing algorithmic strategies;

at the peer node 10b to receive the winning algo, unencrypt it, and use it to place trades on any trading exchange, whether remote or integrated.

Trading Indicators/Parameters: There are several trading indicators known to prior art. Some of them are: exponential moving average (EMA) crossovers, relative strength index (RSI), moving average convergence divergence (MACD), Bollinger bands, so on and so forth. The inventors have implemented as many as 30 indicators in one of their ATR embodiments. The user selects these parameters to design the algorithmic trading strategy.

Algorithmic Trading Strategy (ATS) 14 is a trading strategy designed 14a by the user and leased 14b by the peer lessee. ATS may also be referred as algo-strategy or simply algo.

AI Engine: The ATR clients are endowed with artificial intelligence (AI) module 16 that runs advance machine learning and deep learning algorithms to analyze large amount of global 18 and local 20 surveillance data 22 to determine “go” or “no go” decisions on placing a specific trade 24 on a specific trade exchange 26.

Leaderboarding is a protocol by which the ATS is processed 28 to be published 30 on a leaderboard 32 of top performing ATSs for making it available for peers to securely lease the ATS for their profitable trading.

Smart Lease Contract 34 is a self-executing smart contract between a lessor 10a and a lessee 10b and a key component of the blockchain's distributed ledger system of the algo-sharing network architecture. It is through the smart lease contract that the top performing algos are leased and received 36 by the lessee for deploying it in trades. Self-executing smart contracts of a preferred embodiment can also be implemented by deploying DAG's decentralized architecture.

Consensus Engine 38 is another key component of the blockchain infrastructure wherein each smart contract is verified by peer nodes 40 for adding it to the blockchain's permanent ledger 42 as a new block.

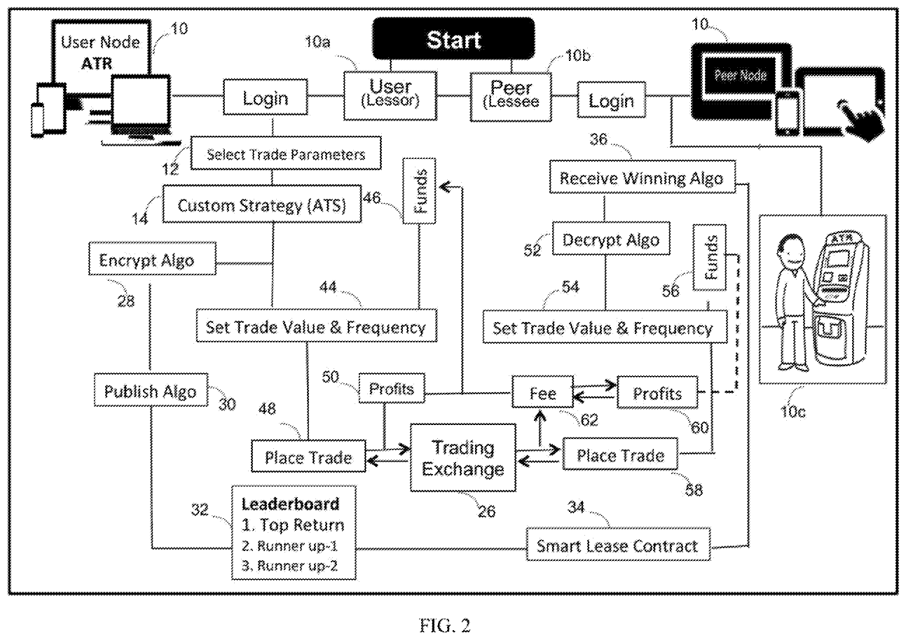

FIG. 2 is a block diagram illustrating the implementation of the novel algo-sharing system of the present invention, which begins with the user signing in to login to the ATR 10 at the user node 10a and selecting 12 their preferred trade parameters from one or more trading indicators to design their custom ATS algorithm 14. Once the custom ATS strategy is finalized the user defines the value and frequency of the financial instruments to trade 44, draws funds from the account wallet 46 and places the trade order 48 on the order book of an online trading exchange 26 using the exchange API (application programming interface). The automated trading is executed as per the custom ATS algorithm, value and frequency set by the user, and the profits 50 are returned to the user's account wallet 46.

The custom ATS 14 is encrypted 28 using 128-bit encryption or similar protocol, and listed in a leaderboard 32 in the order of profits that specific ATS returned from the trades executed. Such leaderboard of the top performing algorithms makes these winning algorithms available to peers under a self-executing smart lease contract terms 34 either based on a fixed fee, or based on a share in the trading profits. The algo performance leaderboard 32 is updated and published either in real time, every minute, every hour, every 12-hours, every 24-hours or every week.

In a preferred embodiment the self-executing smart contract 34 between the user/lessor 10a and the peer/lessee 10b of the leased algorithm 36 is verified by consensus 38 of participating peers 40 and immutably maintained in a database of distributed ledger 42 amongst the participating nodes. Such smart lease contract limits the use of the contracted algo to trading specific financial instruments during specific time periods within specific trading exchanges deploying artificial intelligence for eliminating any residual risk in trading decisions due to any real time changes in market conditions that impact the profitability of the leased algorithm.

The winning algo is received by the peer 36 and decrypted 52 at the peer node 10b and ready for the peer to use it to set trade value and frequency 54, draw funds from the account wallet 56 and places the trade order 58 on the order book of the online trading exchange 26 using the exchange API. The profits 60 from the trade are used to settle the fee 62 accrued to the lessor/owner of the leased ATS algorithm according to the terms of the smart lease contract.

In a preferred embodiment the user and peer nodes include any one of the personal computing devices such as a desktop computer, a handheld mobile device or a smartphone. In yet another preferred embodiment the ATR and the decentralized algo-sharing protocols are integrated and implemented within a trading exchange itself. In one of the preferred embodiments the peer or lessee node is an automatic teller machine 10c for last mile delivery of financial and profit making algo-sharing, algo-trading and financial instrument exchange services to remote end-users who do not have a computer device or chose not to use a personal computer device.

In another preferred embodiment, the efficacy of ATS is determined not only by its leaderboard profitability score, but by the duration of time period the ATS remains profitable. In other words the shelf life of the ATS immensely contributes to the quantum of profits it can return. Since performance of ATS is subjected to multitude of variables, many of which are random events beyond reasonable predictability, estimation of such shelf-life can not be an as exact science as estimating the decay of radioactive material or for that matter the decay of a pharmaceutical agent in human body. Biological decay of matter within a dynamic living system is a lot more complex than degradation of matter in any stable geophysical environment. Therefore, in pharmacokinetics the decay of a pharmaceutical agent within human body is estimated in terms of its half-life rather than its full life. We apply similar principle in estimating shelf life of ATS. However, algokinetics is way to complex than pharmacokinetics. We use stochastic modeling to estimate profitability half-life of ATS.

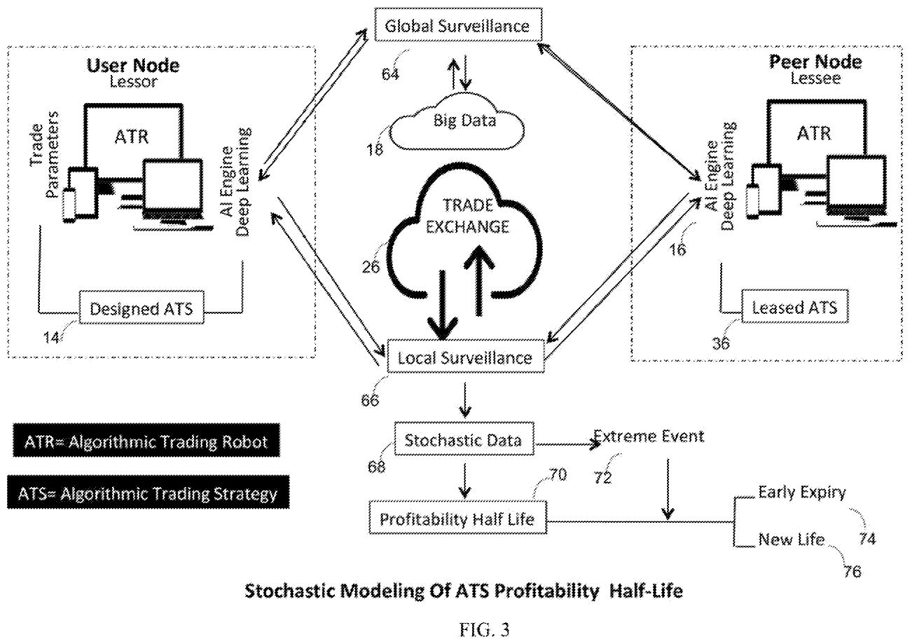

FIG. 3 is a block diagram illustrating stochastic modeling of profitability half-life of ATS. The artificial intelligence (AI) module 16 runs advance machine learning and deep learning algorithms to analyze large amount 18 of global 64 and local 66 surveillance data. The AI module uses such stochastic data from financial markets 68 to model the dynamic half-life of the ATS. Such half-life remains dynamic and subject to change depending on exposure to some extreme random event 72, which may result in shortening the half-life or expiring the ATS 74, or giving the ATS a new life 76.

In one preferred embodiment the algorithmic trading in financial instruments is high frequency trading (HFT) based on value and frequency of the trades defined by each individual peer operating the automated trading robot. In yet another embodiment the algorithmic trading is inter-exchange arbitrage trading or intra-exchange arbitrage trading. In another embodiment of the invention, the algorithm sharing can be applied to any asset that represents value of ownership irrespective of whether it is a financial instrument or not.

In yet another preferred embodiment, the top-performing algorithm or strategy is insured against unforeseeable losses. In still another preferred embodiment of the invention, the blockchain is a low latency scalable blockchain. In yet another preferred embodiment the decentralization of the algo-sharing network is enabled my means of DAG (Directed Acyclic Graph).

In a preferred embodiment the users are offered Zero-Loss loans. Such Zero Loss loans are new class of loans that are 100% secured with almost zero possibility of default. The default possibility approaches zero because:

Firstly, loaned capital cannot be withdrawn or used for any other purpose than algo-trading using the most profitable algorithm topping the leaderboard.

Secondly, the leased algorithm deployed is the most profitable algorithm within its profitability half-life, which as an additional safeguard, is protected against any loss by an artificially intelligent stop-loss mechanism that kills the algo when it ceases to remain profitable.

Zero-Loss financing is therefore 100% secured.

In still another embodiment of the invention, the participating peers are impoverished individuals or their cooperatives and their tradable financial instruments or assets are acquired by secured nano-loans or micro-loans not less than $100 and not more than $1000, under the terms that the loaned principle is exclusively used for algo-trading but cannot be withdrawn, and the trading profits are withdrawable only to the extent that they are over and above the estimated interest on the loan.

Although the present invention has been particularly shown and described with reference to exemplary embodiments thereof, it will be understood by those of ordinary skill in the art that various changes in form and details may be made therein without departing from the spirit and scope of the present invention as defined by the appended claims. Therefore, the present embodiments are to be considered as illustrative and not restrictive and the invention is not to be limited to the written description.

1. A computer-implemented system, apparatus and method of utilizing an autonomous decentralized system of distributed ledger infrastructure and self-executing smart contracts for securely, confidentially and equitably sharing with or leasing to participating peers, top performing algorithmic trading strategies designed by an algorithmic trading robot (ATR), based on a trading algorithm performance global leaderboard, for the purpose of trading financial instruments or assets on one or more trading platforms or exchanges with zero-loss efficiency.

2. The system of claim 1 wherein the financial instruments or assets belong to one or more of the asset class consisting of currencies, stocks, equities, futures, options, commodities, bonds, warrants or cryptocurrencies.

3. The method of claim 1 wherein the specific trading strategy of the top performing algorithm is encrypted and secured using private key and public key infrastructure so that it can neither be replicated nor reconfigured nor reverse engineered by the peers who lease it for placing their trades.

4. The system of claim 1 wherein the trading algorithm performance leaderboard is updated and published either in real time, every minute, every hour, every 12-hours, every 24-hours or every week, and consequently top performing algorithms made available for equitable sharing with or leasing to peers for a consideration that may either be on fixed fee basis, or based on a share in the trading profits according to specific terms defined in the self-executing smart contract.

5. The method of claim 1 wherein the self-executing smart contract between the lessor and the lessee of the leased algorithm is verified by consensus of participating peers and immutably maintained in a database of distributed ledger amongst the participating nodes, and it limits the use of the contracted algo to trading specific financial instruments during specific time periods within specific trading exchanges deploying artificial intelligence for eliminating any residual risk in trading decisions due to any real time changes in market conditions that impact the profitability of the leased algorithm.

6. The zero-loss trading system of claim 1 wherein the top-performing algorithm has a profitability half-life estimated by a built-in deep learning module based on stochastic modeling of data obtained via global and local surveillance of financial markets, such profitability half life is dynamic and varies widely depending on the type of financial instrument traded and random events influencing financial markets.

7. The zero-loss trading system of claim 1 wherein artificial intelligence eliminates all possibilities of losses by:
a. deploying only the most profitable algo within it's estimated profitability half life;
b. killing the algo if unpredictable extreme market conditions makes the algo unprofitable within it's profitability half life;
c. insuring against unforeseeable losses.

8. The method of claim 1 wherein the participating peers are extremely impoverished individuals or their cooperatives with no capital or trading experience, and their tradable financial instruments or assets are acquired through 100% secured zero-loss financing (ZLF) nano-loans or micro-loans not less than $100 and not more than $1000, under terms that the loaned principle is exclusively used for trading but cannot be withdrawn, and the trading profits are withdrawable only to the extent that they are over and above estimated loan interest accrued.

9. The system of claim 1 wherein the apparatus is an automatic teller machine (ATM) for last mile delivery of financial and profit making algo-sharing, algo-trading and financial instrument exchange services to remote end-users who do not have a computer device or chose not to use a personal computer device.

10. The method of claim 1 wherein the algorithmic trading in financial instruments is high frequency trading (HFT) based on value and frequency of the trades defined by each individual peer operating the automated trading robot.

11. The method of claim 1 wherein the algorithmic trading is inter-exchange arbitrage trading or intra-exchange arbitrage trading.

12. The method of claim 1 wherein the algorithm sharing is not limited to financial instruments but includes any asset that represents value of ownership.

13. The method of claim 1 wherein the autonomous decentralized system is either a low latency scalable blockchain infrastructure or other decentralized network architectures such as Directed Acyclic Graph (DAG).

14. The method of claim 1 wherein instead of a decentralized blockchain infrastructure or other decentralized network architectures such as Directed Acyclic Graph (DAG), or the algorithm sharing is implemented using a traditional centralized database infrastructure, or the ATR and the decentralized algo-sharing protocols are integrated and implemented within a trading exchange itself.

15. A computer-implemented method of zero-loss trading utilizing a decentralized system of self-executing smart contracts for equitable sharing or leasing of top performing algorithmic trading strategies among peers for a fee, comprising of the steps of signing in to an algorithmic trading robot (ATR) at a user node, using the trading strategy module of the robot for creating a custom algorithmic strategy (algo) by selecting a combination of indicators, entering the value and frequency of the trades to be executed at the user node, using the custom algo for executing the trades at the user node, encrypting the custom algo at user node, publishing the trading results to a global leaderboard of top performing algos for sharing it with peers, achieving the top spot in the global leaderboard, leasing use of the winning algo to peers by executing a smart contract, transferring the winning algo to the algorithmic trading robot at a peer node, entering the value and frequency of trades to be executed at the peer node, decrypting the algo at the peer node, executing the trade or trades by the trading robot at the peer node, calculating the fee payable by the peer to the user for the volume of trading executed by the leased algo at the peer node, transferring the fee from the peer node to the user node, validating each step to be in compliance with the terms of the smart contract and recording the transaction in the distributed public ledger.

16. The method of claim 15 wherein the algorithmic trading pertains to assets belonging to one or more of the asset class consisting of currencies, stocks, equities, futures, options, commodities, bonds, warrants or cryptocurrencies.

17. The method of claim 15 wherein the algo performance leaderboard is updated and published either in real time, every minute, every hour, every 12-hours, every 24-hours or every week, and consequently top performing algos made available for sharing with or leasing to peers for a consideration that may either be on a fixed fee basis, or based on a share in the trading profits according to specific terms defined in the self-executing smart contract.

18. The method of claim 15 wherein the self-executing smart contract between the lessor and the lessee of the leased algorithm is verified by consensus of participating peers and immutably maintained in a database of distributed ledger amongst the participating nodes, and it limits the use of the contracted algo to trading specific financial instruments during specific time periods within specific trading exchanges deploying artificial intelligence for eliminating any residual risk in trading decisions due to any real time changes in market conditions that impact the profitability of the leased algorithm.

19. The zero-loss trading system of claim 15 wherein the top-performing algorithm has a profitability half-life estimated by a built-in deep learning module based on stochastic modeling of data obtained via global and local surveillance of financial markets, such profitability half life is dynamic and varies widely depending on the type of financial instrument traded and random events influencing financial markets.

20. The system of zero-loss trading of claim 15 wherein artificial intelligence eliminates all possibilities of losses by:
a. deploying only the most profitable algo within it's estimated profitability half life;
b. killing the algo if unpredictable extreme market conditions makes the algo unprofitable within it's profitability half life;
c. insuring against unforeseeable losses.

21. The method of claim 15 wherein the participating peers are extremely impoverished individuals or their cooperatives with no capital or trading experience, and their tradable financial instruments or assets are acquired through 100% secured zero-loss financing (ZLF) nano-loans or micro-loans not less than $100 and not more than $1000, under terms that the loaned principle is exclusively used for trading but cannot be withdrawn, and the trading profits are withdrawable only to the extent that they are over and above estimated loan interest accrued.

22. The method of claim 15 wherein the peer node is a shared node such as an automatic teller machine (ATM) for last mile delivery of financial and profit making algosharing, algotrading and financial instrument exchange services to remote end-users who do not have a computer device or chose not to use a personal computer device.

23. The method of claim 15 wherein the peer nodes run an artificial intelligence engine with deep learning algorithms for analyzing the trading history, patterns and real time market conditions for making a decision on leasing or not leasing a specific winning algorithm despite it's top position on the leaderboard, and for pretesting the profitability of the leased algorithm prior to placing a trade for the purpose of minimizing or eliminating the probability of losses.

24. The method of claim 15 wherein the algorithmic trading in financial instruments is high frequency trading (HFT) based on value and frequency of the trades defined by each individual peer operating the trading robot.

25. The method of claim 15 wherein the algorithmic trading is inter-exchange arbitrage trading or intra-exchange arbitrage trading.

26. The method of claim 15 wherein the specific trading strategy of the top performing algo is encrypted and secured using private key and public key infrastructure so that it can neither be replicated nor reconfigured nor reengineered by the lessee peers.

27. The method of claim 15 wherein the algorithm sharing is not limited to financial instruments but includes any asset that represents value of ownership.

28. The method of claim 15 wherein the autonomous decentralized system is either a low latency scalable blockchain infrastructure or other decentralized network architectures such as Directed Acyclic Graph (DAG).

29. The method of claim 15 wherein instead of a decentralized blockchain infrastructure or other decentralized network architectures such as Directed Acyclic Graph (DAG), or the algorithm sharing is implemented using a traditional centralized database infrastructure, or the ATR and the decentralized algo-sharing protocols are integrated and implemented within a trading exchange itself.
